(19) United States
(12) Patent Application Publication
(10) Pub. No.: US 2012/0055350 A1
(43) Pub. Date: Mar. 8, 2012

(54) Juice Extracting Cup Used in Juice Extractor

(75) Inventor: Jin-Yi HUANG, TAINAN CITY (TW)

(73) Assignees: YA HORNG ELECTRONIC CO., LTD., TAINAN CITY (TW); YA HORNG (DONG GUAN) ELECTRONIC CO., LTD., GUANGDONG PROVINCE (CN)

(21) Appl. No.: 13/045,494

(22) Filed: Mar. 10, 2011

(30) Foreign Application Priority Data
Sep. 7, 2010 (CN) 201020521699.3

(51) Int. Cl. A23N 1/00; A23N 1/02

(52) U.S. Cl. 99/508

(57) ABSTRACT

A juice extracting cup used in a juice extractor comprises a cup body and a filter net. The cup body is hollow and has openings at two ends and several longitudinal ribs projected from inner wall. A supporting strip along the inner wall of the cup body is projected from the inner wall below the several ribs. The filter net is disposed inside the body cup, and several clip strips are projected at the bottom end of outer wall of the filter net. Several openings correspond to the several ribs between every two clip strips, and each of the several openings hosts the respective rib. The several clip strips are clipped between bottom ends of the several ribs and the supporting strip. The juice extracting cup used in the juice extractor according to the present invention can effectively prevent the filter net from falling off and thus the effect of juice extracting can be guaranteed.

### RELATED APPLICATIONS

This application claims priority to Chinese Application Serial Number 201020521699.3, filed Sep. 7, 2010, which is herein incorporated by reference.

### TECHNICAL FIELD

The present invention relates to a juice extracting cup in a juice extractor, especially to the juice extracting cup which can effectively prevent a filter net from falling off.

### BACKGROUND OF THE INVENTION

There are many kinds of juice extracting cups used for a juice extractor now. In order to prevent fruit pulp and fruit marc from entering into juice container, a filter net would be disposed inside the cup body of the cup. The filter net is fixed by means of friction force between ribs on the cup body and the filter net. However, such fixing will cause the filter net to fall off and float upwards during grinding process, and thus the fruit marc and the juice are mixed and cannot be separated easily, so the effect of juice extracting would be decreased.

### SUMMARY OF THE INVENTION

The technical problem to be solved by the present invention is to overcome the problem that the filter net of the existing juice extracting cup for the juice extractor is prone to fall off to cause the juice marc and the juice to be mixed so that the effect of the juice extracting would be affected, and to provide a juice extracting cup which can effectively prevent a filter net from falling off.

In order to solve the above technical problem, a juice extracting cup used in a juice extractor is provided, which comprises a cup body and a filter net, the cup body is hollow and has openings at two ends and several longitudinal ribs projected from inner wall; a supporting strip along the inner wall of the cup body is projected from the inner wall below the several ribs; the filter net is disposed inside the cup body, and several clip strips are projected at the bottom end of outer wall of the filter net; several openings correspond to the several ribs between every two clip strips, and each of the several openings hosts the respective rib; the several clip strips are clipped between bottom ends of the several ribs and the supporting strip.

Preferably, a gap with a certain width is between the bottom end of the respective ribs and the supporting strip.

Preferably, a protruding block is projected at the end of at least one clip strip of the several clip strips, and another protruding block is projected at the central of at least another clip strip.

Preferably, the several ribs are disposed on the inner wall of the cup body at the same distance.

Preferably, the juice extracting cup further comprises a cutting tools combination which is fixed at the bottom end of the cup body and includes a cutting tools block which is fixed at the bottom within the cup body and a blade set including a shaft and several blades on the shaft, the shaft passing through the center of the cutting tools block and rotating therein.

Preferably, a circular groove is cutting on an upper surface of the cutting tools block, and the cutting tools combination further comprises a sealing ring which is set within the circular groove.

Preferably, the juice extracting cup further comprises a lid combination which includes a juice extracting cup lid and a central lid disposed in the middle of the juice extracting cup lid.

The present invention has the following beneficial technical effects: in the present invention, the gap is between the bottom end of the respective ribs and the supporting strip and the clip strip of the filter net can be clipped into the gap; the clip strip can be turned in the gap by means of the simple rotation action, so that the filter net can be clipped between the ribs and the supporting strip of the cup body, therefore the filter net can be amounted in the cup body stably to prevent the filter net from falling off effectively and avoid mixing the juice marc and the juice to improve the effect of the juice extracting. Moreover, the operations on the present invention are simple. In addition, the setup of the protruding block can be used to indicate that the filter net is turned wrongly or the filter net is successfully installed.

### BRIEF DESCRIPTION OF DRAWINGS

FIG. 1 is an exploded perspective view of the juice extracting cup used in a juice extractor according to a first embodiment of the present invention;

FIG. 2 is a vertical view of the cup body of the juice extracting cup used in a juice extractor according to a first embodiment of the present invention;

FIG. 3 is a perspective view of the cup body of the juice extracting cup used in a juice extractor according to a first embodiment of the present invention;

FIG. 4 is a perspective view of the filter net of the juice extracting cup used in a juice extractor according to a first embodiment of the present invention;

FIG. 5 is a vertical view of the filter net of the juice extracting cup used in a juice extractor according to a first embodiment of the present invention;

FIG. 6 is a sectional view of the juice extracting cup used in a juice extractor according to a first embodiment of the present invention;

FIG. 7 is an amplified view of part A of FIG. 6;

FIG. 8 is a schematic diagram showing the clip strip clipped into the gap of the juice extracting cup used in a juice extractor according to a first embodiment of the present invention;

FIG. 9 is an exploded perspective view of the juice extracting cup used in a juice extractor according to a second embodiment of the present invention;

FIG. 10 is a vertical view of the cup body of the juice extracting cup used in a juice extractor according to a second embodiment of the present invention;

FIG. 11 is a vertical view of the filter net of the juice extracting cup used in a juice extractor according to a second embodiment of the present invention;

FIG. 12 is an exploded perspective view of the juice extracting cup used in a juice extractor according to a third embodiment of the present invention;

FIG. 13 is a vertical view of the cup body of the juice extracting cup used in a juice extractor according to a third embodiment of the present invention;

FIG. 14 is a vertical view of the filter net of the juice extracting cup used in a juice extractor according to a third embodiment of the present invention.

### DETAILED DESCRIPTION OF PREFERRED EMBODIMENTS

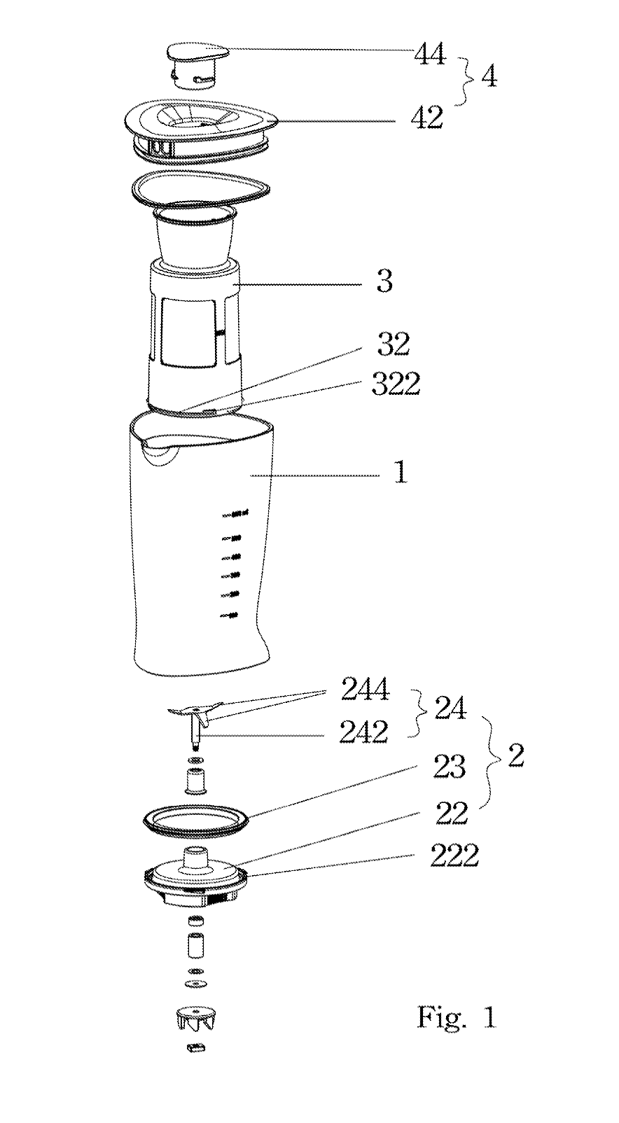

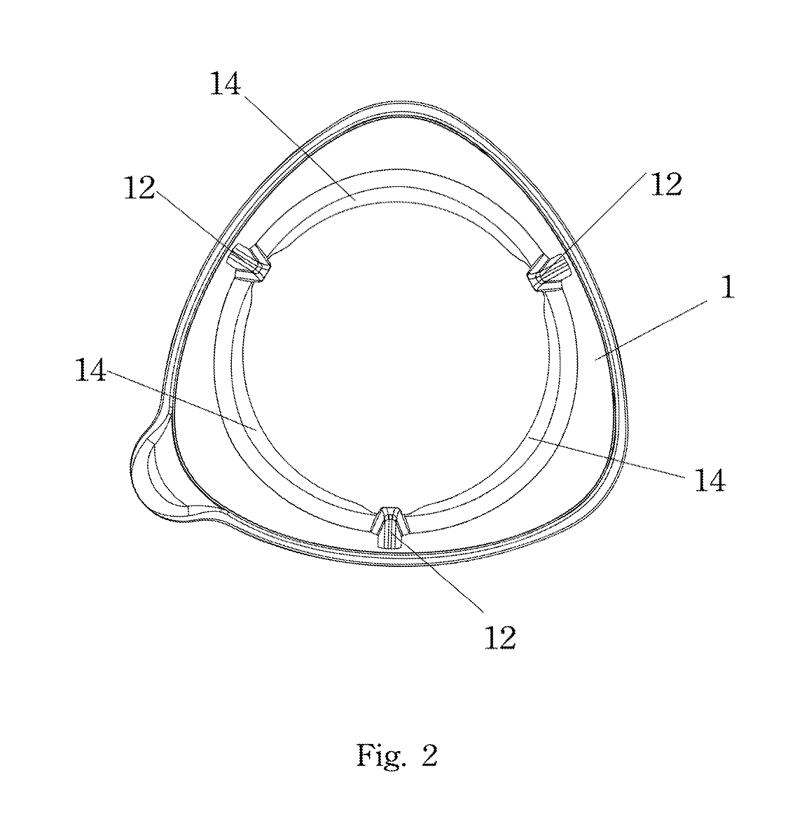

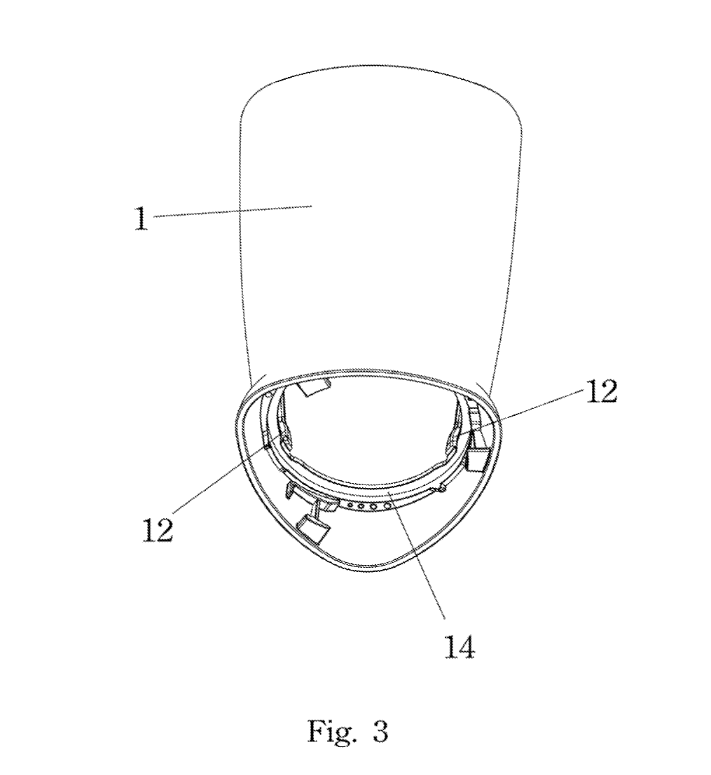

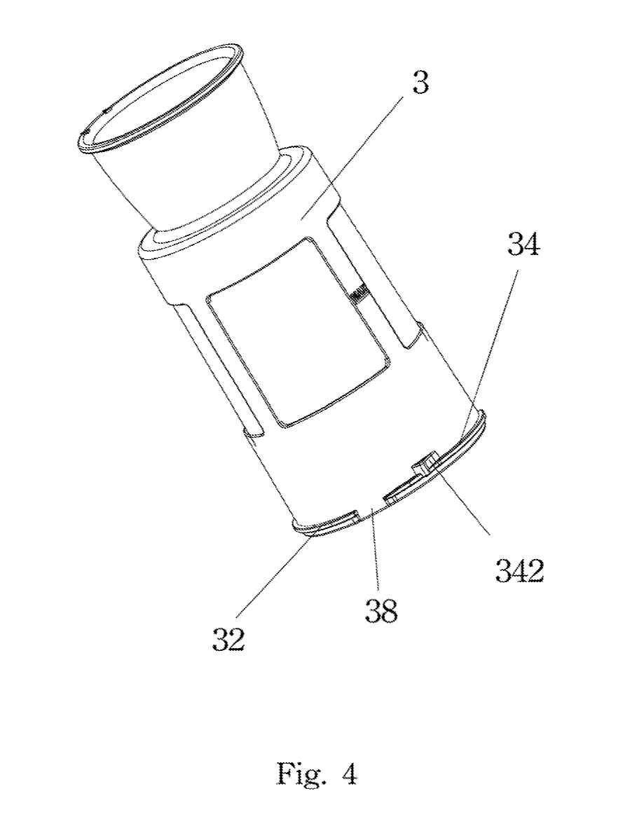

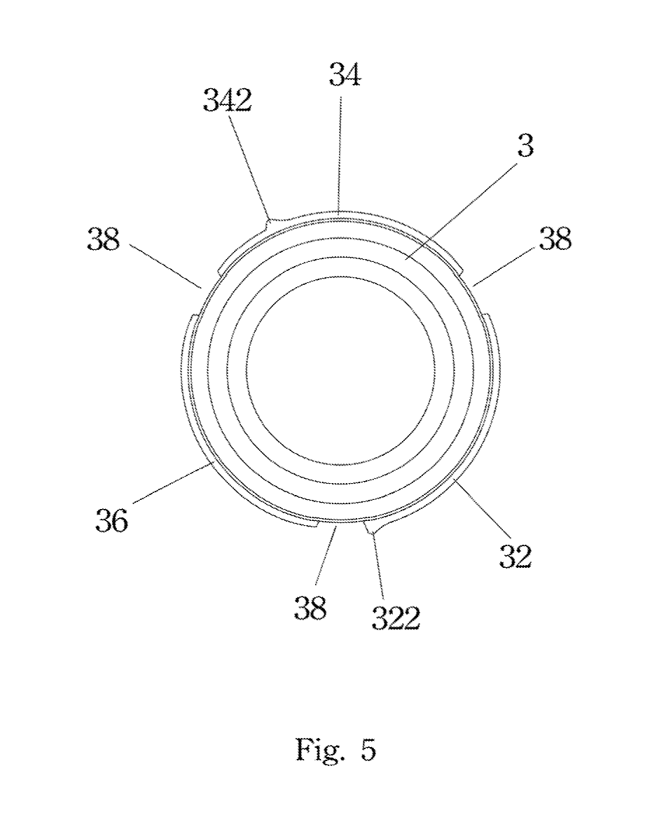

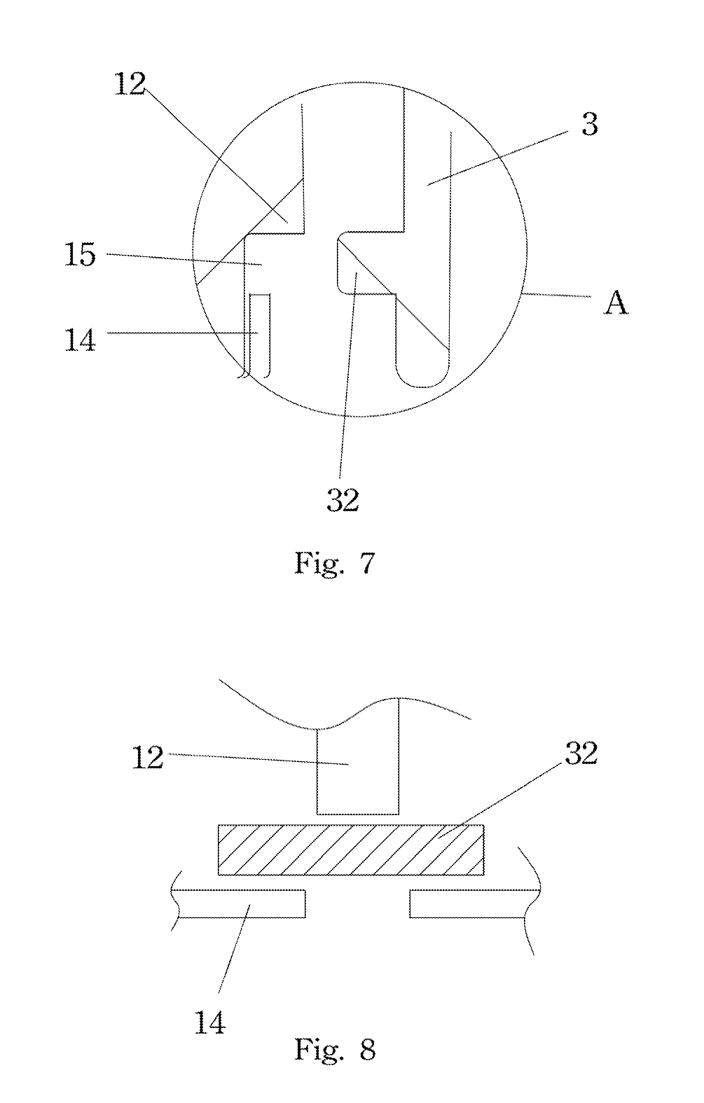

FIGS. 1-8 show a first embodiment of the present invention, in which the juice extracting cup used in a juice extractor comprises a cup body 1, a cutting tools combination 2, a filter net 3 and a lid combination 4.

The cup body 1 is hollow and has openings at two ends. Three longitudinal ribs 12 are projected from inner wall at the same distance.

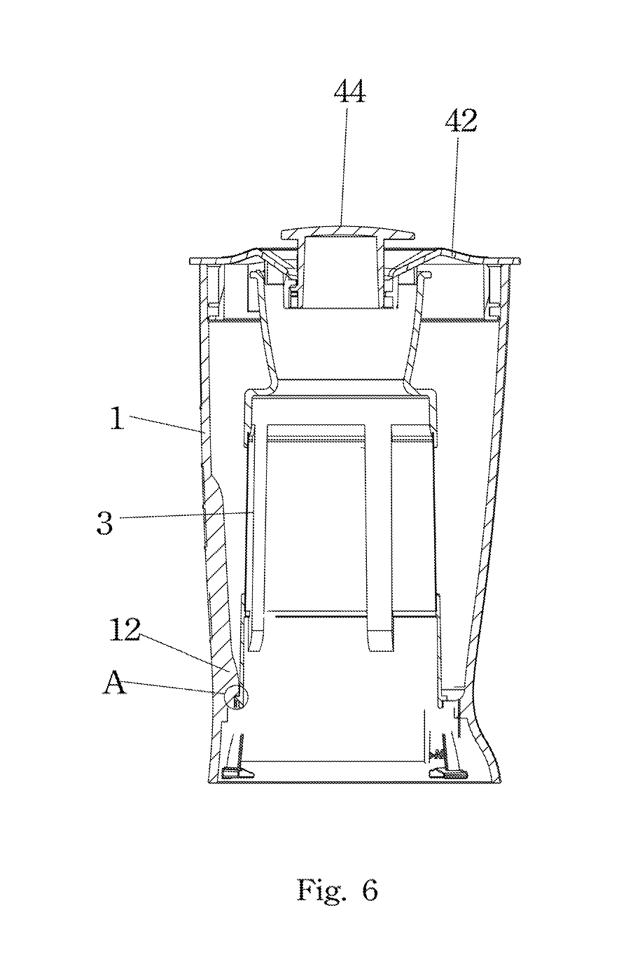

A supporting strip 14 along the inner wall of the cup body 1 is projected from the inner wall of the cup body 1 below the three ribs 12. A gap 15 with a certain width is between the bottom end of the respective ribs 12 and the supporting strip 14 (see FIGS. 6-8), in order to make the bottom end of the filter net 3 clipped into the gap 15 to fix the filter net 3 stably.

The cutting tools combination 2 is fixed at the bottom end of the cup body 1 and includes a cutting tools block 22, a sealing ring 23 and a blade set 24.

The cutting tools block 22 is fixed at the bottom within the cup body 1. A circular groove 222 is on an upper surface of the cutting tools block 22.

The sealing ring 23 is placed into the groove 222 in a manner that the bottom of the sealing ring 23 is clipped into the groove 222. After the placement, the outer side of the sealing ring 23 contacts with the inner wall of the cup body 1. The function of the sealing ring 23 is to reduce shaking and noise, to improve the sealing with the cutting tools block 22 and the cup body 1, and to effectively prevent the electric leakage and troublesome cleaning caused by the juice entering into the cutting tools block 22.

The blade set 24 includes a shaft 242 and three blades 244 set on the shaft 242. The shaft 242 passes through the center of the cutting tools block 22, and can rotate therein. The three blades 244 rotate with the shaft 242 to grind the fruits in the cup body 1.

The filter net 3 is disposed inside the cup body 1, and a first clip strip 32, a second clip strip 34 and a third clip strip 36 are projected at the bottom end of outer wall of the filter net 3. Three openings 38 correspond to the three ribs 12 between every two clip strips, and each of the three openings 38 hosts the respective ribs 12.

A protruding block 322 is projected upward at the end of the first clip strip 32.

Another protruding block 342 is projected upward at the central of the second clip strip 34.

The lid combination 4 includes a juice extracting cup lid 42 and a central lid 44. The central lid 44 is disposed in the middle of the juice extracting cup lid 42.

During the installment, firstly the cutting tool combination 2 is amounted on the bottom of the cup body 1. The filter net 3 is moved into the cup body 1 through the upper opening of the cup body 1 with the three ribs 12 being in the three openings 38 respectively. The filter net 3 is moved continuously until the first, second and third clip strips 32, 34, 36 press the supporting strip 14 of the cup body 1. At this time, the filter net 3 cannot be moved any more. Then the filter net 3 is turned. Since there is the gap 15 between the bottom ends of the three ribs 12 and the supporting strip 14, the first, second and third clip strips 32, 34, 36 can be turned in the gap 15. When the protruding block 342 of the second clip strip 34 is held by the rib 12, the filter net 3 cannot be turned any more, which indicates that the filter net 3 is successfully installed. The first, second and third clip strips 32, 34, 36 of the filter net 3 are clipped between the bottom ends of the three ribs 12 and the supporting strip 14, so the filter net 3 is fixed on the cup body 1 stably and is not easy to fall off, thus the fruit marc and the juice cannot be mixed together and the effect of juice extracting can be guaranteed.

When taking out the filter net 3, the filter net 3 is turned reversely, so that the three openings 38 can face to the three ribs 12. Then the filter net 3 is taken out, causing the three ribs 12 into the three openings 38. Thus the filter net 3 can be taken out from the cup body 1. The operation is very simple and easy.

The function of the protruding block 322 at the end of the first clip strip 32 is that when installing the filter net 3, the rib 12 would hold the block 322 if the filter net 3 is turned wrongly, so as to prevent the filter net 3 from being turned and indicate the user that the filter net 3 should be turned reversely.

The function of the protruding block 342 at the central of the second clip strip 34 is that: when installing the filter net 3, the protruding block 342 would be hold by the rib 12 after the filter net 3 is turned in the gap 15 for a while, so as to prevent the filter net from being turned and indicate the user that the filter net 3 is successfully fixed.

In the present invention, there is the gap 15 between the bottom ends of the three ribs 12 and the supporting strip 14 of the cup body 1. The first, second and third clip strips 32, 34, 36 of the filter net 3 can be put into the gap 15 (see FIGS. 6-8). The first, second and third clip strips 32, 34, 36 can be turned in the gap 15 by means of the simple operation, thus the filter net 3 can be clipped between the three ribs 12 and the supporting strip 14 of the cup body 1. Therefore, the filter net 3 can be installed in the cup body 1 stably to effectively prevent the filter net 3 from falling off, further to avoid mixing the fruit marc and the juice, and improve the effect of extracting the juice. Moreover, the operation is very simple and easy to perform. In addition, the setup of the protruding block 322 can help to indicate the user that the filter net 3 is turned wrongly, and the setup of the protruding block 342 can help to indicate the user that the filter net 3 is successfully installed.

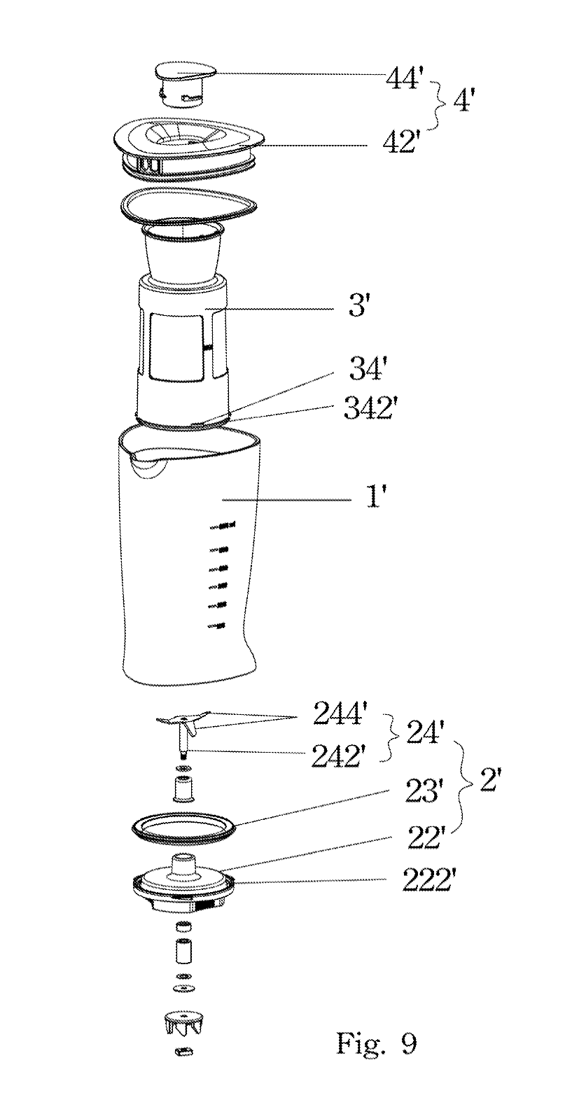

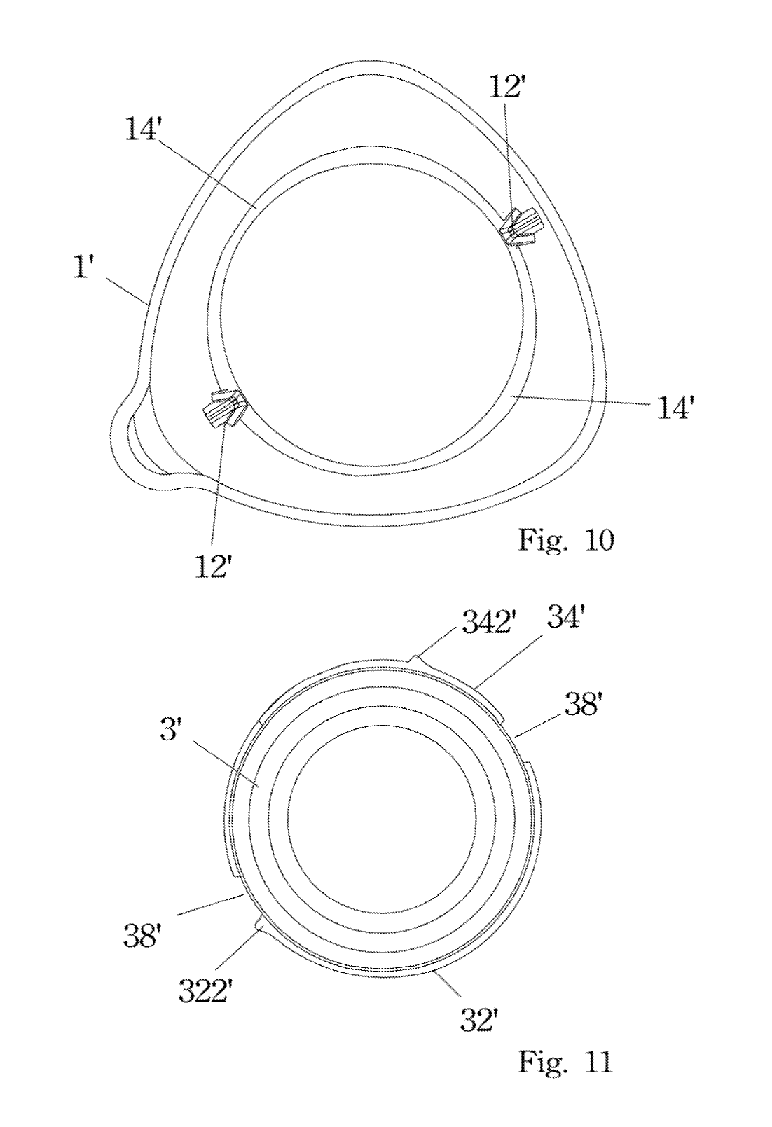

FIGS. 9-11 show a second embodiment of the present invention, in which the juice extracting cup used in a juice extractor comprises a cup body 1′, a cutting tools combination 2′, a filter net 3′ and a lid combination 4′.

The cup body 1′ is hollow and has openings at two ends. Two longitudinal ribs 12′ are projected from inner wall at the same distance.

A supporting strip 14′ along the inner wall of the cup body 1′ is projected from the inner wall of the cup body 1′ below the two ribs 12′. A gap (not shown in FIGS.) with a certain width is between the bottom end of the respective ribs 12′ and the supporting strip 14′, in order to make the bottom end of the filter net 3′ clipped into the gap to fix the filter net 3′ stably. The cutting tools combination 2′ is fixed at the bottom end of the cup body 1′ and includes a cutting tools block 22′, a sealing ring 23′ and a blade set 24′.

The cutting tools block 22′ is fixed at the bottom within the cup body 1′. A circular groove 222′ is on an upper surface of the cutting tools block 22′.

The sealing ring 23′ is placed into the groove 222′ in a manner that the bottom of the sealing ring 23′ is clipped into the groove 222′. After the placement, the outer side of the sealing ring 23′ contacts with the inner wall of the cup body 1′. The function of the sealing ring 23′ is to reduce shaking and noise, to improve the sealing with the cutting tools block 22′ and the cup body 1′, and to effectively prevent the electric leakage and troublesome cleaning caused by the juice entering into the cutting tools block 22′.

The blade set 24′ includes a shaft 242′ and three blades 244′ set on the shaft 242′. The shaft 242′ passes through the center of the cutting tools block 22′, and can rotate therein. The three blades 244′ rotate with the shaft 242′ to grind the fruits in the cup body 1′.

The filter net 3′ is disposed inside the cup body 1′, and a first clip strip 32′ and a second clip strip 34′ are projected at the bottom end of outer wall of the filter net 3′. Two openings 38′ correspond to the two ribs 12′ between every two clip strips, and each of the two openings 38′ hosts the respective ribs 12′.

A protruding block 322′ is projected upward at the end of the first clip strip 32′.

Another protruding block 342′ is projected upward at the central of the second clip strip 34′.

The lid combination 4′ includes a juice extracting cup lid 42′ and a central lid 44′. The central lid 44′ is disposed in the middle of the juice extracting cup lid 42′.

During the installment, firstly the cutting tool combination 2′ is amounted on the bottom of the cup body 1′. The filter net 3′ is moved into the cup body 1′ through the upper opening of the cup body 1′ with the two ribs 12′ being in the two openings 38′ respectively. The filter net 3′ is moved continuously until the first and second clip strips 32′, 34′ press the supporting strip 14′ of the cup body 1′. At this time, the filter net 3′ cannot be moved any more. Then the filter net 3′ is turned. Since there is the gap between the bottom ends of the two ribs 12′ and the supporting strip 14′, the first and second clip strips 32′, 34′ can be turned in the gap. When the protruding block 342′ of the second clip strip 34′ is held by the rib 12′, the filter net 3′ cannot be turned any more, which indicates that the filter net 3′ is successfully installed. The first and second clip strips 32′, 34′ of the filter net 3′ are clipped between the bottom ends of the two ribs 12′ and the supporting strip 14′, so the filter net 3′ is fixed on the cup body 1′ stably and is not easy to fall off, thus the fruit marc and the juice cannot be mixed together and the effect of juice extracting can be guaranteed.

When taking out the filter net 3′, the filter net 3′ is turned reversely, so that the two openings 38′ can face to the two ribs 12′. Then the filter net 3′ is taken out, causing the two ribs 12′ into the two openings 38′. Thus the filter net 3′ can be taken out from the cup body 1′. The operation is very simple and easy.

The function of the protruding block 322′ at the end of the first clip strip 32′ is that when installing the filter net 3′, the rib 12′ would hold the block 322′ if the filter net 3′ is turned wrongly, so as to prevent the filter net 3′ from being turned and indicate the user that the filter net 3′ should be turned reversely.

The function of the protruding block 342′ at the central of the second clip strip 34′ is that: when installing the filter net 3′, the protruding block 342′ would be hold by the rib 12′ after the filter net 3′ is turned in the gap for a while, so as to prevent the filter net from being turned and indicate the user that the filter net 3′ is successfully fixed. In the present invention, there is the gap between the bottom ends of the two ribs 12′ and the supporting strip 14′ of the cup body 1′. The first and second clip strips 32′, 34′ of the filter net 3′ can be put into the gap. The first and second clip strips 32′, 34′ can be turned in the gap by means of the simple operation, thus the filter net 3′ can be clipped between the two ribs 12′ and the supporting strip 14′ of the cup body 1′. Therefore, the filter net 3′ can be installed in the cup body 1′ stably to effectively prevent the filter net 3′ from falling off, further to avoid mixing the fruit marc and the juice, and improve the effect of extracting the juice. Moreover, the operation is very simple and easy to perform. In addition, the setup of the protruding block 322′ can help to indicate the user that the filter net 3′ is turned wrongly, and the setup of the protruding block 342′ can help to indicate the user that the filter net 3′ is successfully installed.

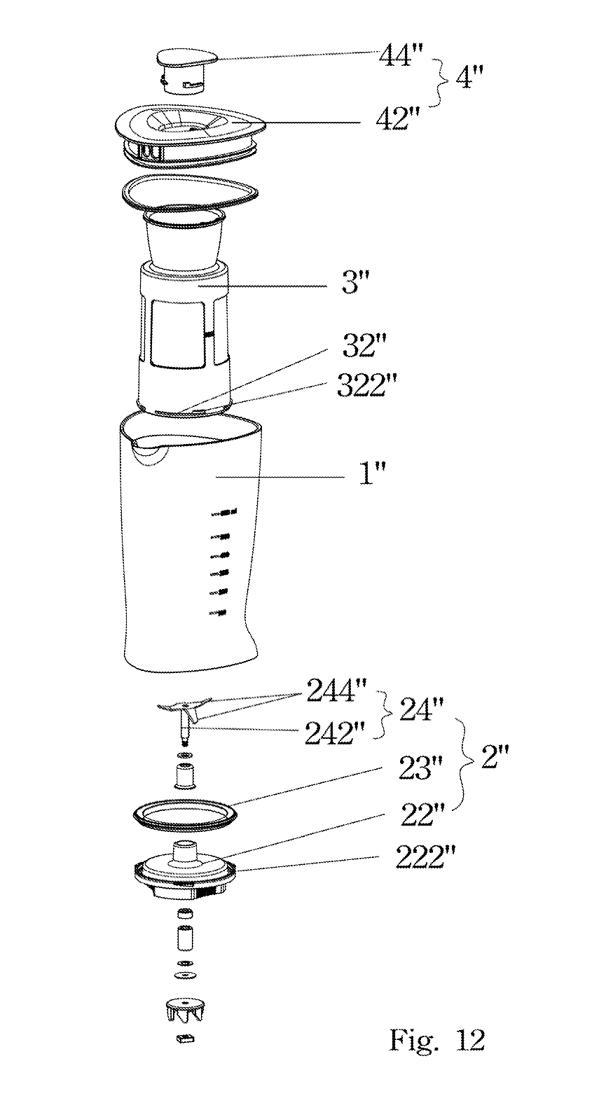

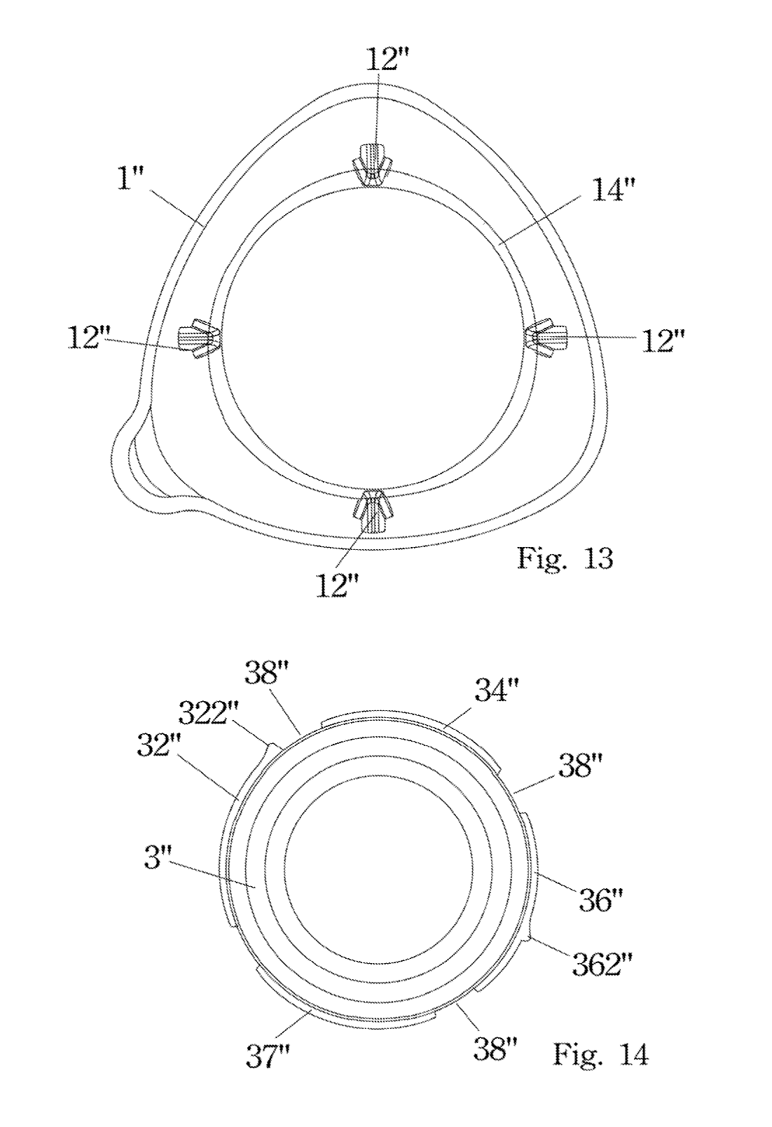

FIGS. 12-14 show a third embodiment of the present invention, in which the juice extracting cup used in a juice extractor comprises a cup body 1″, a cutting tools combination 2″, a filter net 3″ and a lid combination 4″.

The cup body 1″ is hollow and has openings at two ends. Four longitudinal ribs 12″ are projected from inner wall at the same distance.

A supporting strip 14″ along the inner wall of the cup body 1″ is projected from the inner wall of the cup body 1″ below the four ribs 12″. A gap (not shown in FIGS.) with a certain width is between the bottom end of the respective ribs 12′ and the supporting strip 14″, in order to make the bottom end of the filter net 3″ clipped into the gap to fix the filter net 3″ stably.

The cutting tools combination 2″ is fixed at the bottom end of the cup body 1″ and includes a cutting tools block 22″, a sealing ring 23″ and a blade set 24″.

The cutting tools block 22″ is fixed at the bottom within the cup body 1″. A circular groove 222″ is on an upper surface of the cutting tools block 22″.

The sealing ring 23″ is placed into the groove 222″ in a manner that the bottom of the sealing ring 23″ is clipped into the groove 222″. After the placement, the outer side of the sealing ring 23″ contacts with the inner wall of the cup body 1″. The function of the sealing ring 23″ is to reduce shaking and noise, to improve the sealing with the cutting tools block 22″ and the cup body 1″, and to effectively prevent the electric leakage and troublesome cleaning caused by the juice entering into the cutting tools block 22″.

The blade set 24″ includes a shaft 242″ and three blades 244″ set on the shaft 242″. The shaft 242″ passes through the center of the cutting tools block 22″, and can rotate therein. The three blades 244″ rotate with the shaft 242″ to grind the fruits in the cup body 1″.

The filter net 3″ is disposed inside the cup body 1″, and a first clip strip 32″, a second clip strip 34″, a third clip strip 36″ and a fourth clip strip 37″ are projected at the bottom end of outer wall of the filter net 3″. Four openings 38″ correspond to the four ribs 12″ between every two clip strips, and each of the four openings 38″ hosts the respective ribs 12″.

A protruding block 322″ is projected upward at the end of the first clip strip 32″.

Another protruding block 362″ is projected upward at the central of the third clip strip 36″.

The lid combination 4″ includes a juice extracting cup lid 42″ and a central lid 44″. The central lid 44″ is disposed in the middle of the juice extracting cup lid 42″.

During the installment, firstly the cutting tool combination 2″ is amounted on the bottom of the cup body 1″. The filter net 3″ is moved into the cup body 1″ through the upper opening of the cup body 1″ with the four ribs 12″ being in the four openings 38″ respectively. The filter net 3″ is moved continuously until the first, second, third and fourth clip strips 32″, 34″, 36″ and 37″ press the supporting strip 14″ of the cup body 1″. At this time, the filter net 3″ cannot be moved any more. Then the filter net 3″ is turned. Since there is the gap between the bottom ends of the four ribs 12″ and the supporting strip 14″, the first, second, third and fourth clip strips 32″, 34″, 36″ and 37″ can be turned in the gap. When the protruding block 362″ of the third clip strip 36″ is held by the rib 12″, the filter net 3″ cannot be turned any more, which indicates that the filter net 3″ is successfully installed. The first, second, third and fourth clip strips 32″, 34″, 36″ and 37″ of the filter net 3″ are clipped between the bottom ends of the four ribs 12″ and the supporting strip 14″, so the filter net 3″ is fixed on the cup body 1″ stably and is not easy to fall off, thus the fruit marc and the juice cannot be mixed together and the effect of juice extracting can be guaranteed.

When taking out the filter net 3″, the filter net 3″ is turned reversely, so that the two openings 38″ can face to the four ribs 12″. Then the filter net 3″ is taken out, causing the four ribs 12″ into the four openings 38″. Thus the filter net 3″ can be taken out from the cup body 1″. The operation is very simple and easy.

The function of the protruding block 322″ at the end of the first clip strip 32″ is that when installing the filter net 3″, the rib 12″ would hold the block 322″ if the filter net 3″ is turned wrongly, so as to prevent the filter net 3″ from being turned and indicate the user that the filter net 3″ should be turned reversely.

The function of the protruding block 362″ at the central of the third clip strip 36″ is that: when installing the filter net 3″, the protruding block 362″ would be hold by the rib 12″ after the filter net 3″ is turned in the gap for a while, so as to prevent the filter net 3″ from being turned and indicate the user that the filter net 3″ is successfully fixed.

In the present invention, there is the gap between the bottom ends of the four ribs 12″ and the supporting strip 14″ of the cup body 1″. The first, second, third and fourth clip strips 32″, 34″, 36″ and 37″ of the filter net 3″ can be put into the gap. The first, second, third and fourth clip strips 32″, 34″, 36″ and 37″ can be turned in the gap by means of the simple operation, thus the filter net 3″ can be clipped between the four ribs 12″ and the supporting strip 14″ of the cup body 1″. Therefore, the filter net 3″ can be installed in the cup body 1″ stably to effectively prevent the filter net 3″ from falling off, further to avoid mixing the fruit marc and the juice, and improve the effect of extracting the juice. Moreover, the operation is very simple and easy to perform. In addition, the setup of the protruding block 322″ can help to indicate the user that the filter net 3″ is turned wrongly, and the setup of the protruding block 362″ can help to indicate the user that the filter net 3″ is successfully installed.

1. A juice extracting cup used in a juice extractor, comprising a cup body and a filter net, the cup body being hollow and having openings at two ends and several longitudinal ribs projected from inner wall, characterized in that:
a supporting strip along the inner wall of the cup body is projected from the inner wall below the several ribs;
the filter net is disposed inside the cup body, several clip strips are projected at a bottom end of outer wall of the filter net, several openings correspond to the several ribs between every two clip strips, each of the several openings hosts the respective rib;
the several clip strips are clipped between bottom ends of the several ribs and the supporting strip.

2. The juice extracting cup used in a juice extractor according to claim 1, characterized in that: a gap with a certain width is between the bottom ends of the respective ribs and the supporting strip.

3. The juice extracting cup used in a juice extractor according to claim 1, characterized in that: a protruding block is projected at the end of at least one clip strip of the several clip strips, and another protruding block is projected at the central of at least another clip strip.

4. The juice extracting cup used in a juice extractor according to claim 1, characterized in that: the several ribs are disposed on the inner wall of the cup body at the same distance.

5. The juice extracting cup used in a juice extractor according to claim 1, characterized in that: the juice extracting cup further comprises a cutting tools combination which is fixed at the bottom end of the cup body and includes a cutting tools block which is fixed at the bottom within the cup body and a blade set including a shaft and several blades on the shaft, the shaft passing through the center of the cutting tools block and rotating therein.

6. The juice extracting cup used in a juice extractor according to claim 5, characterized in that: the cutting tools combination further comprises a sealing ring which is set within a circular groove on an upper surface of the cutting tools block.

7. The juice extracting cup used in a juice extractor according to claim 1, characterized in that: the juice extracting cup further comprises a lid combination which includes a juice extracting cup lid and a central lid disposed in the middle of the juice extracting cup lid.
